(19) United States
(12) Patent Application Publication
(10) Pub. No.: US 2026/0350199 A1
(43) Pub. Date: Nov. 5, 2026

(54) TECHNOLOGIES FOR USER RISK PROFILING

(71) Applicant: Abdul Badruddin, Lawrenceville, GA (US)

(72) Inventor: Abdul Badruddin, Lawrenceville, GA (US)

(21) Appl. No.: 19/666,364

(22) Filed: May 4, 2026

Related U.S. Application Data
(60) Provisional application No. 63/799,441, filed on May 3, 2025.

(51) Int. Cl. G06F 21/62; G06F 21/57

(52) U.S. Cl. CPC G06F 21/6218; G06F 21/577; G06F 2221/034

(57) ABSTRACT

Systems and methods are provided for managing interactions between a user device and artificial intelligence (AI) tools based on an assessment of data risk associated with the user device. Data associated with the user device may be analyzed using one or more machine learning techniques to identify potentially sensitive or high-risk information. Based on the analysis, a risk indication may be generated and used to determine one or more controls governing interactions with an AI tool. Inputs from the user device to the AI tool may be monitored and, in some cases, modified in accordance with the determined controls prior to transmission. The disclosed techniques enable adaptive management of AI tool usage to reduce the likelihood of exposure of sensitive information.

### CROSS-REFERENCE TO RELATED APPLICATIONS

This patent application claims priority to U.S. Provisional Patent Application Ser. No. 63/799,441, filed May 3, 2025, which is incorporated by reference in entirety herein.

### FIELD

The present disclosure relates generally to computer systems, data security, and artificial intelligence (AI) technologies. More particularly, the present disclosure relates to technologies for controlling interactions with and modifying data transmitted to AI tools based on assessed risk.

### BACKGROUND

Enterprise organizations are increasingly adopting artificial intelligence (AI) systems, including generative AI tools, to enhance productivity, automate workflows, and assist users in generating content. Such tools may include large language models, code generation systems, and other AI-driven applications that accept user inputs and generate outputs based on those inputs.

Despite benefits provides by AI tools, the integration of AI tools into enterprise environments introduces significant risks related to the inadvertent disclosure of sensitive information. For instance, users may input confidential data into AI systems, including personally identifiable information (PII), protected health information (PHI), financial data, proprietary business information, or other regulated or sensitive content. In many cases, such inputs may be transmitted to external systems or third-party service providers, potentially resulting in unauthorized exposure or loss of control over sensitive data.

Conventional approaches to mitigating these risks are generally limited in effectiveness. For example, enterprises may implement static data loss prevention (DLP) policies or rely on user training and awareness programs. However, such approaches often fail to account for differences in user behavior, context, or risk levels. Static policies may be overly restrictive for some users while insufficiently protective for others. Further, traditional monitoring systems may operate reactively, identifying issues only after sensitive data has already been transmitted.

### SUMMARY

One embodiment presented herein discloses a computer-implemented method. The method generally includes analyzing files stored on a user device using a machine learning model to identify data that may be considered high risk. Based on this analysis, a risk score is generated for the user device. A policy is then determined according to the risk score, where the policy governs how the user device is permitted to interact with an artificial intelligence (AI) tool. Inputs from the user device to the AI tool are intercepted, and inputs that are not permitted under the policy are modified in accordance with the policy before being transmitted.

Another embodiment presented herein discloses a system that includes one or more processors and a memory storing instructions. When executed, the instructions cause the system to analyze files stored on a user device using a machine learning model to identify high-risk data, generate a risk score based on the analysis, and determine a policy based on the risk score. The system further intercepts inputs from the user device to an AI tool and modifies inputs that are prohibited under the policy in accordance with the policy.

Yet another embodiment presented herein discloses a computer-readable storage medium that stores instructions which, when executed by one or more processors, cause a system to perform operations including analyzing files stored on a user device using a machine learning model to identify high-risk data, generating a risk score based on the analysis, determining a policy based on the risk score, intercepting inputs from the user device to an AI tool, and modifying inputs that are prohibited under the policy in accordance with the policy.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates a conceptual diagram of an example computing environment in which an artificial intelligence (AI) risk management system is deployed, according to one embodiment;

FIG. 2 illustrates a block diagram of an example computing system that may be used to implement one or more components of the computing environment of FIG. 1, according to one embodiment;

FIG. 3 illustrates a conceptual diagram of an example system for generating a user risk profile based on analysis of data associated with a user device, including aggregation of file-based and browser-based risk indicators, according to one embodiment;

FIG. 4 illustrates a flow diagram of an example method for generating a risk score and enforcing a policy governing interactions between a user device and an AI tool, according to one embodiment; and

FIG. 5 illustrates a conceptual diagram of an example machine learning pipeline for generating a risk score based on user device data, including feature extraction, classification, and aggregation of risk indicators, according to one embodiment.

### DETAILED DESCRIPTION

Embodiments presented herein disclose technologies for assessing a risk associated with a user or computing device and dynamically controlling interactions with artificial intelligence (AI) tools based on the assessed risk. In particular, the disclosed technology uses machine learning techniques to analyze data associated with a user device, generate a risk profile, and enforce adaptive policies governing the transmission of data to AI systems.

As further described herein, the disclosed technology addresses technical challenges arising from the integration of AI tools into enterprise computing environments. Conventional approaches to data protection, such as static data loss prevention (DLP) rules or post hoc monitoring systems, are often insufficient to prevent inadvertent disclosure of sensitive information in real time. Such approaches generally lack the ability to adapt to variations in user behavior, device-specific context, or dynamically changing risk conditions.

By contrast, the systems and methods described herein provide a proactive and adaptive mechanism for controlling interactions with AI tools. By leveraging machine learning models to analyze data stored on a user device (e.g., files, metadata, usage patterns, etc.) the disclosed technology generates a quantitative risk score indicative of a likelihood that sensitive data may be exposed. The disclosed technology may use the risk store to determine one or more policies that govern how inputs to AI tools are processed, including whether to allow, modify, restrict, or block such inputs.

In one or more embodiments, the disclosed technology further provides real-time interception and modification of user inputs to AI tools. For example, a browser extension, endpoint agent, or similar component may intercept a user-provided prompt (e.g., including plain text, image attachments, document file attachments, etc.) prior to transmission to an AI system. The disclosed technology may analyze the intercepted input using one or more machine learning models or rule-based systems to identify sensitive content. Based on an applicable policy, portions of the input may be redacted, masked, or otherwise modified, or the input may be blocked entirely. Such real-time enforcement provides a significant technical improvement over conventional approaches that operate only after data has already been transmitted.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

Additionally, the disclosed technology enables granular and user-specific policy enforcement. Rather than applying uniform restrictions across all users, the system dynamically tailors enforcement based on an individualized risk profile. Doing so allows for more efficient use of computing resources and reduces unnecessary restrictions for low-risk users while providing enhanced protection for higher-risk scenarios. Such adaptive behavior improves both system performance and usability within enterprise environments.

In some embodiments, the disclosed technology also supports continuous monitoring and dynamic updating of risk profiles. As user behavior changes over time, or as new data is identified on the user device, the risk score may be recalculated and corresponding policies adjusted accordingly. Doing so enables the system to respond to evolving conditions without requiring manual intervention.

Advantageously, the disclosed technology improves functioning of computing systems by introducing a coordinated architecture that integrates local data analysis, machine learning-based classification, and real-time input control. By reducing unnecessary data transmission, preventing leakage of sensitive information, and enabling efficient policy enforcement, the disclosed technology enhances both the security and operational efficiency of systems that interact with AI tools.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

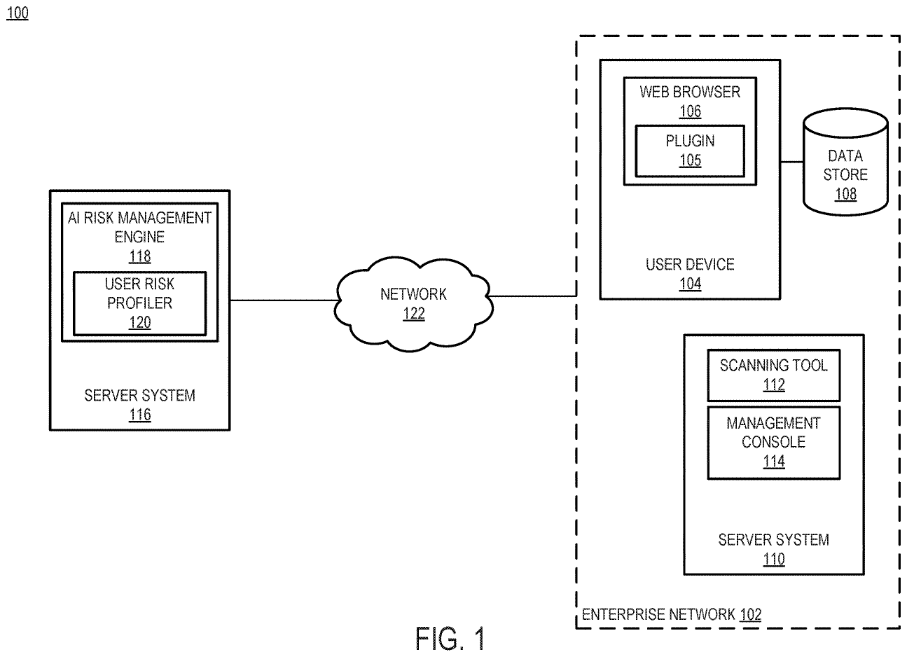

Referring now to FIG. 1, a computing environment 100 is shown for managing interactions between a user device and one or more artificial intelligence (AI) tools based on a dynamically determined risk profile. The computing environment 100 includes an enterprise network 102, a network 122, and a server system 116. The network 122 may include one or more public or private networks, such as the Internet, a local area network (LAN), a wide area network (WAN), or combinations thereof.

The enterprise network 102 includes a user device 104, which may be any computing device associated with a user, including a laptop, desktop computer, mobile device, or virtual workstation. The user device 104 may include a web browser 106 configured to access web-based AI tools, a data store 108 storing local files and user data, and a plugin 105 or other local application configured to monitor and control user interactions. In some embodiments, the plugin 105 may be implemented as a browser extension, a background agent, an operating system-level service, a network proxy component, and so on. The plugin 105 may be configured to intercept inputs entered by a user into AI tools and to communicate with other components of the system for analysis and enforcement.

The enterprise network 102 may further include a server system 110, which may be one or more servers responsible for coordinating scanning, policy management, and administrative control. The server system 110 may include a scanning tool 112 configured to analyze files stored on the user device 104. In some embodiments, the scanning tool 112 may perform local or remote file scanning, extract content and metadata, and interface with machine learning models for classification. The system 100 may also include a management console 114, configured to provide administrative control and visibility. The management console 114 may display risk scores and user profiles, allow administrators to define or adjust policies, provide reporting and audit functions, and enable configuration of enforcement rules across multiple user devices.

The computing environment 100 further includes a server system 116, which may be located within or external to the enterprise network 102. The server system 116 includes an AI risk management engine 118. The AI risk management engine 118 may be configured to, valuate data associated with user devices, generate risk scores or profiles, determine policies governing AI tool usage, and enforce restrictions on data transmitted to AI tools. In some embodiments, the AI risk management engine 118 includes a user risk profiler 120, which may aggregate outputs from one or more machine learning models, compute a risk score based on identified high-risk data, and incorporate additional signals such as user behavior or browsing activity.

The AI risk management engine 118 and/or the scanning tool 112 may use one or more machine learning models configured to identify high-risk data. The models may Analyze file contents, metadata, or patterns, detect categories of sensitive data such as PII, PHI, or proprietary information, output classifications, scores, or probabilities, and the like. In an embodiment, the machine learning models may be deployed locally on the user device 104, within the enterprise server system 110, on the server system 116, or in some combination.

Based on the generated risk score, the AI risk management engine 118 may determine one or more policies associated with the user device 104. For instance, policies may define whether user inputs to AI tools are allowed, whether sensitive portions should be redacted, whether inputs should be blocked entirely, whether user activity should be logged or reported, and so on. Enforcement of the policies may occur at various points, including at the plugin 105 on the user device 104, at a network gateway, at the server system, etc.

The user device 104 may interact with one or more external AI tools, which may include generative AI system, chat-based assistants, code generation tools, data analysis platforms, and so on. The plugin 105 may intercept inputs provided to such AI tools via the web browser 106 or other interfaces. Intercepted inputs may be transmitted to the AI risk management engine 118 for evaluation or processed locally using a machine learning model. Based on the applicable policy, the input may be allowed Allowed without modification, modified (e.g., redacted or masked), or blocked from transmission.

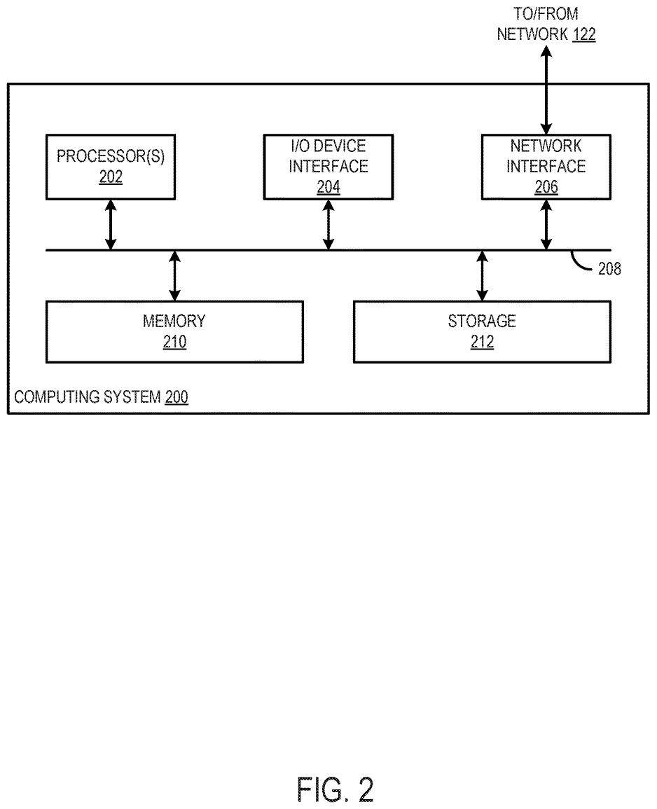

Referring now to FIG. 2, a block diagram illustrating hardware components of an example computing system 200 (e.g., user device 104, server systems 110, 116, etc.). As shown, computing system 200 includes, without limitation, a one or more processors 202, an input/output (I/O) device interface 204, a network interface 206, a memory 210, and a storage 212, each interconnected via a hardware bus 208. Of course, the actual computing system 200 will include a variety of additional hardware components not shown. Additionally, in some embodiments, one or more of the illustrative components may be incorporated in, or otherwise form a portion of, another component.

The processors 202 retrieve and execute programming instructions stored in the memory 210. The processors 202 may be embodied as one or more processors, each processor being a type capable of performing the functions described herein. For example, the processors 202 may be embodied as a single or multi-core processor(s), a microcontroller, or other processor or processing/controlling circuit. In some embodiments, the processors 202 may be embodied as, include, or be coupled to a field programmable gate array (FPGA), an application-specific integrated circuit (ASIC), reconfigurable hardware or hardware circuitry, or other specialized hardware to facilitate performance of the functions described herein. The hardware bus 208 is used to transmit instructions and data between the processors 202, storage 212, network interface 206, and the memory 210. The processors 202 are included to be representative of a single CPU, multiple CPUs, a single CPU having multiple processing cores, and the like.

The memory 210 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

The network interface 206 may be embodied as any hardware, software, or circuitry (e.g., a network interface card) used to connect the computing system 200 over the network 122 and providing the network communication component functions described above. For example, the network interface 206 may be embodied as any communication circuit, device, or collection thereof, capable of enabling communications over the network 122 between the computing system 200 and other devices. The network interface 206 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the network interface 206 may include a network interface controller (NIC, not shown), embodied as one or more add-in-boards, daughtercards, controller chips, chipsets, or other devices that may be used by the computing system 200 for network communications with remote devices. For example, the NIC may be embodied as an expansion card coupled to the I/O device interface 204 over an expansion bus such as PCI Express.

The I/O device interface 204 allows I/O devices to communicate with hardware and software components of the computing system 200. For example, the I/O device interface 204 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O device interface 204 may form a portion of a system-on-a-chip (SoC) and be incorporated, along with one or more of the processors 202, the memory 210, and other components of the computing system 200. The I/O devices may be embodied as any type of I/O device connected with or provided as a component to the computing system 200. I/O devices such as keyboards, mice, and printers may be included as I/O devices.

The storage 212 may be embodied as any type of device configured for short-term or long-term storage of data such as, for example, memory devices and circuits, memory cards, hard disk drives (HDDs), solid-state drives (SSDs), or other data storage devices. The storage 212 may include a system partition that stores data and firmware code for the storage 212. The storage 212 may also include an operating system partition that stores data files and executables for an operating system.

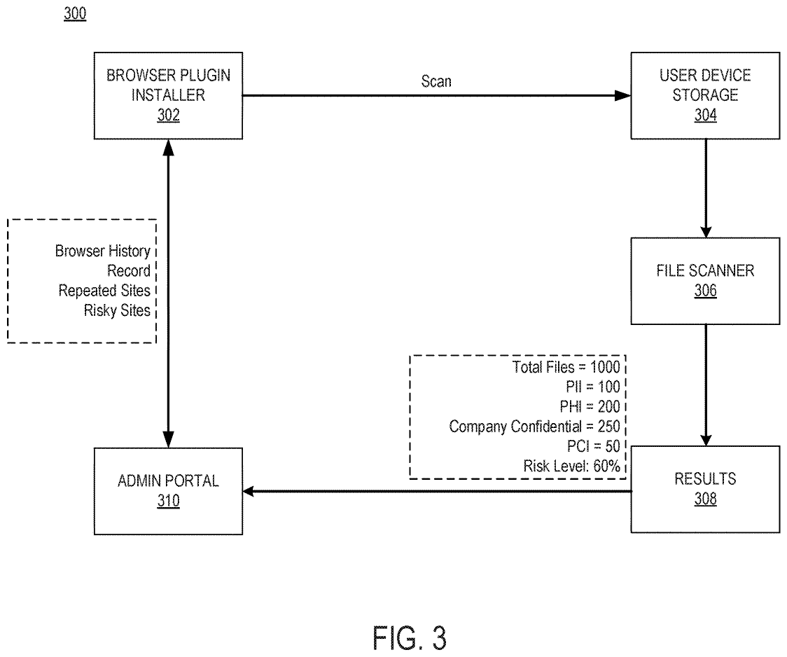

Referring now to FIG. 3, an example conceptual diagram 300 of an example of an example system and process for generating a user risk profile based on data associated with a user device is shown. Illustratively, a browser plugin installer 302 is deployed on a user device to enable monitoring and scanning functionality. The plugin, once installed, may interface with components of the user device and associated enterprise systems. The user device includes a storage device 304 (e.g., a hard disk drive, solid state drive, networked storage drive, etc.) that stores multiple heterogenous files, such as image files, email files, document files, text files, and other data. A file scanner is configured to access and analyze the files (at 306). In some embodiments, the file scanner uses one or more machine learning models and/or pattern-matching techniques (e.g., regex) to evaluate file contents and identify data indicative of risk. If a match is present, the machine learning model may return a value indicating that the file likely contains high-risk data. In an embodiment, the machine learning model may return a score indicating a likelihood that the file contains high-risk data. In an embodiment, the machine learning model may provide a count of files in the user device storage likely storing high-risk data and generate, based on the count, the user risk profile.

Results of the analysis are aggregated and presented (at 308). The results may include summary metrics such as a total number of files analyzed and counts of files associated with various data categories. As illustrated, such categories may include personally identifiable information (PII), protected health information (PHI), company confidential data, and payment card information (PCI). The results may further include a computed risk level associated with the user device, which may be expressed as a numerical score or percentage. In addition to file-based analysis, the system may incorporate browser-related data, such as browser history records, identification of repeatedly visited sites, and identification of sites associated with elevated risk. Such information may be used to augment the determination of the risk level.

An administrative portal may be provided to enable monitoring and management of risk profiles associated with one or more user devices (at 310). The administrative portal may receive the aggregated results and provide interfaces for reviewing risk metrics, initiating scans, and configuring policies based on the determined risk level.

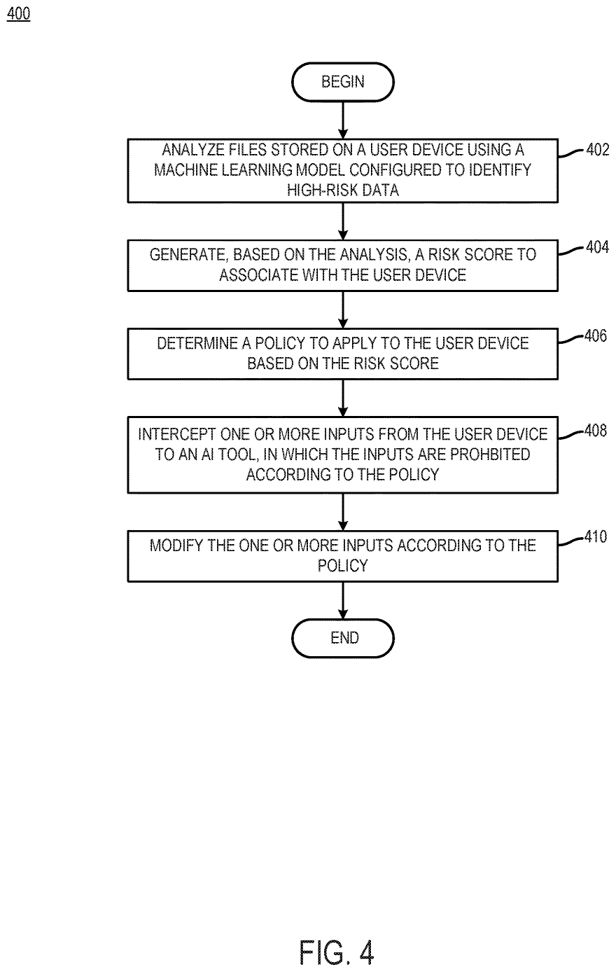

Referring now to FIG. 4, the server system 116, in operation, may perform a method 400 for generating a risk score for a user device and enforcing a policy for interactions with an artificial intelligence (AI) tool, according to one embodiment. The method 400 may be performed, in whole or in part, by the server system 116 of FIG. 1, such as by the AI risk management engine 118 and/or the user risk profiler 120.

At block 402, the server system 116 analyzes files stored on a user device using a machine learning model configured to identify high-risk data. For example, the user risk profiler 120 may receive file data, file metadata, extracted text, hashes, embeddings, feature vectors, or scan results from the user device 104, the plugin 105, and/or the scanning tool 112. The server system 116 may apply one or more machine learning models to the received information to classify files as containing, or being likely to contain, high-risk data. High-risk data may include, for example, personally identifiable information, protected health information, payment card information, confidential enterprise information, proprietary information, regulated information, or other information designated by an enterprise policy.

In some embodiments, the server system 116 does not receive full file contents. Instead, the user device 104 or scanning tool 112 may perform local preprocessing and transmit extracted features, redacted snippets, classification signals, counts, metadata, or other derived information to the server system 116. In other embodiments, the server system 116 receives file contents or portions thereof and performs the classification remotely.

At block 404, the server system 116 generates, based on the analysis, a risk score to associate with the user device. For example, the user risk profiler 120 may aggregate file-level classifications, confidence values, counts of high-risk files, data-category labels, file locations, file types, recency of access, and/or browser-history indicators to determine an overall risk score. The risk score may be expressed as a numerical value, percentage, tier, label, or other risk measure. In one example, files classified as containing PHI, PII, company confidential information, or PCI data may be weighted differently, and the weighted values may be combined to produce the risk score.

At block 406, the server system 116 determines a policy to apply to the user device based on the risk score. For example, the AI risk management engine 118 may compare the risk score to one or more policy thresholds or rules stored by the server system 116. Based on the comparison, the AI risk management engine 118 may select a policy tier, such as a permissive tier, monitoring tier, redaction tier, blocking tier, or administrator-approval tier. The selected policy may specify actions to be taken when the user device interacts with one or more AI tools, including whether inputs may be allowed, logged, redacted, blocked, quarantined, or submitted for review.

At block 408, the server system 116 intercepts, or causes interception of, one or more inputs from the user device to an AI tool. For example, the AI risk management engine 118 may receive an input from the plugin 105 before the input is transmitted to an AI tool. In another example, the server system 116 may provide policy instructions to the plugin 105, a browser extension, endpoint agent, secure gateway, proxy, or enterprise application that intercepts the input locally or at a network boundary. The intercepted input may include a text prompt, file upload, pasted content, attachment, code snippet, document excerpt, or other information intended for submission to the AI tool.

At block 410, the server system 116 modifies the one or more inputs according to the policy. For example, the AI risk management engine 118 may analyze the intercepted input to detect sensitive portions and may return instructions to redact, mask, tokenize, truncate, or remove those portions. In some embodiments, the server system 116 may modify the input itself and return a modified version to the user device for transmission to the AI tool. In other embodiments, the server system 116 may instruct the plugin 105 or other enforcement component to perform the modification locally. Where the policy prohibits transmission, the server system 116 may cause the input to be blocked and may log the attempted transmission or generate an alert.

The method 400 may be repeated periodically, continuously, or in response to triggering events. For example, the server system 116 may update the risk score when new files are detected, when browser history changes, when the user attempts to access an AI tool, or when an administrator modifies enterprise policy settings.

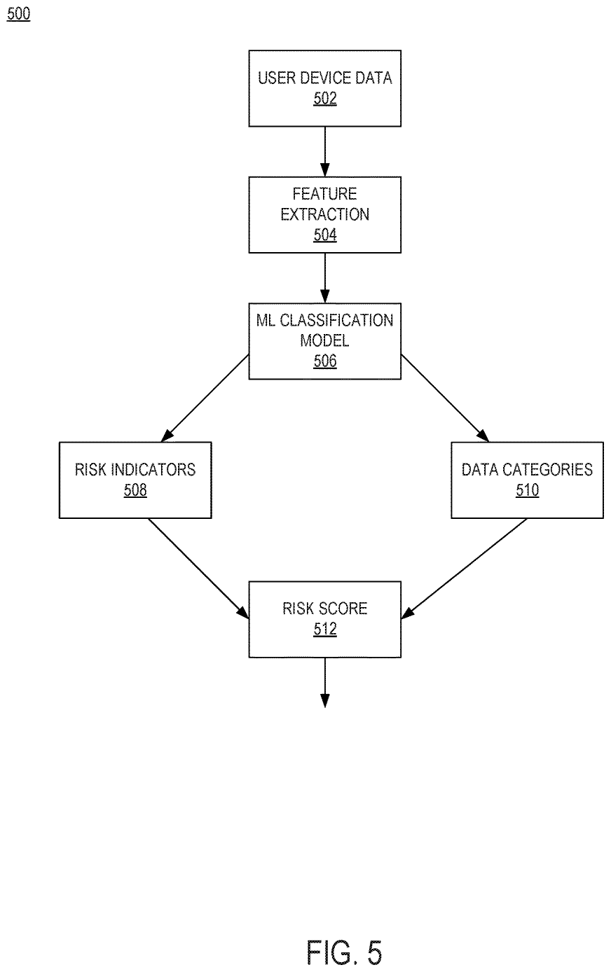

Referring now to FIG. 5, a conceptual diagram of an example machine learning pipeline 500 for generating a risk score associated with a user device, according to one embodiment. The pipeline 500 may be implemented, in whole or in part, by the server system 116 of FIG. 1, such as by the AI risk management engine 118 and/or the user risk profiler 120.

The pipeline 500 receives user device data 502 as input. In some embodiments, the user device data 502 is transmitted from the user device 104, plugin 105, and/or scanning tool 112. The user device data 502 may include file contents, extracted text, metadata, file attributes (e.g., file type, size, location), access history, hashes, embeddings, classification signals, and/or browser-related data such as visited URLs or site categories. In some embodiments, the user device data 502 includes preprocessed or partially redacted data generated locally on the user device to reduce data transmission.

At a feature extraction stage 504, the server system 116 processes the user device data 502 to generate feature representations suitable for machine learning analysis. For example, the user risk profiler 120 may tokenize text, identify keywords or patterns, extract entities (e.g., names, account numbers, medical terms), generate embeddings using a natural language processing model, and/or derive statistical features such as frequency counts, entropy measures, or pattern matches. The feature extraction stage 504 may also normalize or encode metadata, such as file types or access frequency, into structured feature vectors.

The extracted features are provided to a machine learning (ML) classification model 506. The classification model 506 may be executed by the AI risk management engine 118 and may include one or more models, such as neural networks, gradient boosting models, support vector machines, or other supervised or unsupervised learning models. The classification model 506 processes the feature vectors to determine whether the corresponding data is indicative of high-risk content. In some embodiments, the model outputs one or more probabilities, confidence scores, or classification labels for each analyzed item.

Based on the output of the classification model 506, the server system 116 generates one or more risk indicators 508. The risk indicators 508 may include per-file scores, binary flags indicating presence of sensitive data, confidence values, or other metrics reflecting the likelihood that the analyzed data contains high-risk information.

In addition, the server system 116 may assign one or more data categories 510 to the analyzed data. For example, the AI risk management engine 118 may classify content into categories such as personally identifiable information (PII), protected health information (PHI), payment card information (PCI), confidential enterprise data, or other predefined categories. In some embodiments, category assignment may be performed by the same machine learning model 506 or by one or more additional classification models or rule-based systems.

The user risk profiler 120 then aggregates the risk indicators 508 and/or data categories 510 to generate a risk score 512 associated with the user device. For example, the server system 116 may compute the risk score 512 by applying weights to different categories of data, summing or averaging per-file scores, incorporating counts of high-risk files, and/or factoring in contextual signals such as recency of access or frequency of interaction. The aggregation may include normalization, scaling, or mapping to predefined risk tiers.

In some embodiments, the risk score 512 is stored by the server system 116 and associated with a user, user device, or account. The risk score 512 may be periodically recomputed as new data is received or as user behavior changes. The computed risk score 512 may be provided to the AI risk management engine 118 for use in determining and enforcing policies governing interactions with AI tools, as described with respect to FIG. 4.

While the foregoing is directed to embodiments of the present disclosure, other and further embodiments of the disclosure may be devised without departing from the basic scope thereof, and the scope thereof may be determined by the example claims that follow.

1. A computer-implemented method, comprising:
analyzing, by one or more processors, a plurality of files stored on a user device using a machine learning model configured to identify high-risk data;
generating, by the one or more processors and based on the analysis of the plurality of files, a risk score associated with the user device;
determining, by the one or more processors, a policy to apply to the user device based on the risk score;
intercepting, by the one or processors, one or more inputs from the user device to an artificial intelligence (AI) tool, the one or more inputs prohibited for transmission to the AI tool according to the policy; and
modifying, by the one or more processors, the one or more inputs according to the policy.

2. The computer-implemented method of claim 1, further comprising transmitting the modified one or more inputs to the AI tool.

3. The computer-implemented method of claim 1, wherein the high-risk data comprises at least one of personally identifiable information (PII), protected health information (PHI), financial data, or proprietary enterprise data.

4. The computer-implemented method of claim 1, wherein determining the policy comprises selecting from a plurality of policy tiers based on thresholds of the risk score.

5. The computer-implemented of claim 1, wherein the policy includes at least one of allowing transmission of the one or more inputs without modification, redacting a portion of the one or more inputs, blocking transmission of the input, or logging the input.

6. The computer-implemented method of claim 1, further comprising updating the risk score based on ongoing usage activity of the user device.

7. The computer-implemented method of claim 1, further comprising generating a graphical user interface displaying the risk score and identified high-risk data categories.

8. A system comprising:
one or more processors; and
a memory storing a plurality of instructions, which, when executed on the one or more processors, causes the system to:
analyze a plurality of files stored on a user device using a machine learning model configured to identify high-risk data;
generate, based on the analysis of the plurality of files, a risk score associated with the user device;
determine a policy to apply to the user device based on the risk score;
intercept one or more inputs from the user device to an artificial intelligence (AI) tool, the one or more inputs prohibited for transmission to the AI tool according to the policy;
and modify the one or more inputs according to the policy.

9. The system of claim 8, wherein the plurality of instructions further causes the system to transmit the modified one or more inputs to the AI tool.

10. The system of claim 8, wherein the high-risk data comprises at least one of personally identifiable information (PII), protected health information (PHI), financial data, or proprietary enterprise data.

11. The system of claim 8, wherein to determine the policy comprises selecting from a plurality of policy tiers based on thresholds of the risk score.

12. The system of claim 8, wherein the policy includes at least one of allowing transmission of the one or more inputs without modification, redacting a portion of the one or more inputs, blocking transmission of the input, or logging the input.

13. The system of claim 8, wherein the plurality of instructions further causes the system to update the risk score based on ongoing usage activity of the user device.

14. The system of claim 8, wherein the plurality of instructions further causes the system to generate a graphical user interface displaying the risk score and identified high-risk data categories.

15. A computer-readable storage medium comprising a plurality of instructions, which, when executed on one or more processors, causes a system to:
analyze a plurality of files stored on a user device using a machine learning model configured to identify high-risk data;
generate, based on the analysis of the plurality of files, a risk score associated with the user device;
determine a policy to apply to the user device based on the risk score;
intercept one or more inputs from the user device to an artificial intelligence (AI) tool, the one or more inputs prohibited for transmission to the AI tool according to the policy; and
modify the one or more inputs according to the policy.

16. The computer-readable storage medium of claim 15, wherein the plurality of instructions further causes the system to transmit the modified one or more inputs to the AI tool.

17. The computer-readable storage medium of claim 15, wherein the high-risk data comprises at least one of personally identifiable information (PII), protected health information (PHI), financial data, or proprietary enterprise data.

18. The computer-readable storage medium of claim 15, wherein to determine the policy comprises selecting from a plurality of policy tiers based on thresholds of the risk score, and wherein the policy includes at least one of allowing transmission of the one or more inputs without modification, redacting a portion of the one or more inputs, blocking transmission of the input, or logging the input.

19. The computer-readable storage medium of claim 15, wherein the plurality of instructions further causes the system to update the risk score based on ongoing usage activity of the user device.

20. The computer-readable storage medium of claim 15, wherein the plurality of instructions further causes the system to generate a graphical user interface displaying the risk score and identified high-risk data categories.
